(19) United States
(12) Patent Application Publication
(10) Pub. No.: US 2012/0307846 A1
(43) Pub. Date: Dec. 6, 2012

(54) DIGITAL BROADCAST TRANSMITTER AND DIGITAL BROADCAST RECEIVER, AND METHOD FOR PROCESSING STREAMS THEREOF

(75) Inventors: Se-ho Myung, Suwon-si (KR); Hyun-koo Yang, Seoul (KR); Hak-ju Lee, Incheon (KR); Jin-hee Jeong, Yongin-si (KR)

(73) Assignee: SAMSUNG ELECTRONICS CO., LTD., Suwon-si (KR)

(21) Appl. No.: 13/518,196

(22) PCT Filed: Dec. 21, 2010
(86) PCT No.: PCT/KR2010/009153

§ 371 Date: Jun. 21, 2012

Related U.S. Application Data
(60) Provisional application No. 61/288,538, filed on Dec. 21, 2009.

(51) Int. Cl. H04J 3/02

(52) U.S. Cl. 370/537

(57) ABSTRACT

Provided is a digital broadcast transmitter including a MUX and an exciter, which construct streams including first service data and second service data that are different from each other. The exciter interleaves streams such that the first service data has a first body, a first head, and a first tail, the second service data has a second body, a second head, and a second tail, and the first head or the first tail is engaged with the second head or the second tail, at the interface between the first service data and the second service data, wherein at least a portion of the second service data is LDPC-coded or turbo-coded, and the rest of the second service data is TCM-coded.

### CROSS-REFERENCE TO RELATED APPLICATION(S)

This application claims priority under 35 U.S.C. §119 from U.S. patent application Ser. No. 61/288,538, filed on Dec. 21, 2009, in the United States Patent and Trademark Office and is a National Stage of PCT Application No. PCT/KR2010/009153, filed on Dec. 21, 2010, the disclosures of which are incorporated herein by reference in its entirety.

### BACKGROUND

1. Field

The present general inventive concept generally relates to a digital broadcast transmitter, a digital broadcast receiver, and a method for processing streams thereof, and more particularly, to a digital broadcast transmitter having improved data transmission efficiency, a digital broadcast receiver, and a method for processing streams thereof

2. Description of the Related Art

Various types of electronic devices have supported digital broadcast services with the supply of digital broadcasting. In particular, besides an apparatus such as a digital broadcast TV, a set-top box, or the like installed in a general home, a portable device held by a person, e.g., a portable phone, a navigation system, a personal digital assistant (PDA), an MP3 player, or the like, has a function of supporting a digital broadcast service.

Therefore, digital broadcasting standards have been discussed to provide a digital broadcast service to such a portable device.

According to conventional digital broadcasting standards, a data stream is coded and then transmitted through one unified encoding method such as trellis encoding. However, applying one fixed encoding method as described above results in deteriorating data transmission efficiency.

In particular, unconventional Advanced Television System Committee (ATSC) standards which define the transmission of only a general normal stream, and digital broadcasting standards, such as ATSC-MH standards which define the transmission of a normal stream and a mobile stream, have been discussed.

However, the digital broadcasting standards require a method of improving transmission efficiency of a mobile stream part.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a digital broadcast transmitter which applies different coding methods to a plurality of pieces of service data to code and transmit the plurality of pieces of service data in order to improve data transmission efficiency, a digital broadcast receiver which receives a transmission stream from the digital broadcast transmitter and processes the transmission stream, and a method for processing streams thereof.

According to an aspect of the exemplary embodiments, there is provided a digital broadcast transmitter including: a MUX unit which constructs a stream including different types of first and second service data; an exciter unit which interleaves the stream constructed by the MUX unit to construct a transmission stream, wherein the exciter unit interleaves the stream so that the first service data includes a first body, and a first head and a first tail which protrudes from the first body and have horn shapes, the second service data includes a second body, and a second head and a second tail which protrude from the second body and have horn shapes, and the first head or tail of the first service data is engaged with the second head or tail of the second service data on an interface between the first and second service data, performs Low Density Parity Check (LDPC)-coding or turbo-coding with respect to at least a part of the second service data of the transmission stream, and performs trellis-code modulation (TCM)-coding with respect to a remaining part.

The exciter unit may include: an interleaver which interleaves the stream; a trellis encoder which performs the TCM-coding; an advance encoder which performs the LDPC coding or the turbo coding; and a controller which controls the advance encoder to code the second body of the interleaved stream and controls the trellis encoder to code the remaining part except the second body.

The MUX unit may include: a formatter which performs formatting to arrange the second service data in a whole area allocated to the second service data.

The exciter unit may include: a randomizer which randomizes the stream constructed by the MUX unit; an RS encoder which performs RS-encoding; a first switch which transmits the randomized stream to the RS encoder and, if the second body of the second service data is input, bypasses the randomized stream; an interleaver which interleaves the stream RS-encoded by the RS encoder and the stream bypassed by the first switch; a trellis encoder which performs the TCM coding; an advance encoder which performs the LDPC-coding or the turbo-coding; a second switch switches the stream interleaved by the interleaver to the trellis encoder or the advance encoder; and a controller which controls the second switch to transmit the second body of the second service data to the advance encoder and transmit the remaining part except the second body to the trellis encoder.

The exciter unit may include: a randomizer which randomizes the stream constructed by the MUX unit; an RS encoder which performs RS-encoding; an advance encoder which performs coding by using the LDPC-coding or the turbo-coding; a formatter formats data coded by the advance encoder to construct a stream comprising the data and connection data; a first switch transmits the randomized stream to the RS encoder and, if the area in which the second service data is arranged comes, transmits the randomized stream to the advance encoder; an interleaver which multiplexes the streams transmitted from the formatter and the RS encoder to perform interleaving; a trellis encoder which codes the stream interleaved by the interleaver by using a TCM-coding method; and a second switch which transmits the stream interleaved by the interleaver to the trellis encoder and, if a part coded by the advance encoder is input, bypasses the stream.

The exciter unit may include: a randomizer which randomizes the stream constructed by the MUX unit; an RS encoder which performs RS-encoding; an advance encoder which performs coding by using the LDPC-coding or the turbo-coding; a formatter which formats data coded by the advance encoder to construct a stream comprising connection data; a first switch which transmits the randomized stream to the RS encoder and, if the second service data is input, transmits the randomized stream to the advance encoder; an interleaver which multiplexes the streams transmitted from the formatter and the RS encoder to perform interleaving; a trellis encoder which codes the stream interleaved by the interleaver by using the TCM-coding method; a second switch transmits the stream interleaved by the interleaver to the trellis encoder and, if a part coded by the advance encoder is input, bypasses the stream; and a connection data inserter which, if the trellis encoder transmits the part coded by the advance encoder transmits to the second switch, generates connection data with reference to a value stored in an internal memory of the trellis encoder and inserts the connection data into a connection area.

The connection data may be arranged around an interface between the first service data and the second service on the interface in a structure of the interleaved stream to continuously perform TCM-coding with respect to parts before and after the second head or the second tail.

According to another aspect of the exemplary embodiments, there is provided a method for processing a stream of a digital broadcast transmitter. The method may include: constructing a stream including different types of first and second service data; and interleaving the stream to construct a transmission stream, wherein the stream is interleaved so that the first service data includes a first body, and a first head and a first tail which protrudes from the first body and have horn shapes, the second service data includes a second body, and a second head and a second tail which protrude from the second body and have horn shapes, and the first head or tail of the first service data is engaged with the second head or tail of the second service data on an interface between the first and second service data, LDPC-coding or turbo-coding is performed with respect to at least a part of the second service data of the transmission stream, and TCM-coding is performed with respect to a remaining part.

The LDPC-coding or the turbo-coding may be performed with respect to only the second body, and the TCM-coding may be performed with respect to a remaining part except the second body.

The constructing of the stream may include: performing formatting to arrange the second service data in a whole area allocated to the second service data.

The constructing of the transmission stream may include: randomizing the stream; RS-encoding the randomized stream and, if the second body is input, bypassing the randomized stream; interleaving the RS-encoded data and the bypassed data; and performing the LDPC-coding or the turbo-coding with respect to the second body of the interleaved stream and performing the TCM-coding with respect to the remaining part except the second body.

The constructing of the transmission stream may include: randomizing the stream; performing RS-encoding with respect to the randomized stream and, if the second service data is input, performing coding and formatting by using the LDPC-coding or the turbo-coding to construct a stream comprising the coded data and connection data; interleaving the constructed stream; and coding the interleaved stream by using a TCM-coding method, wherein the coding of the interleaved stream by using the TCM-coding method includes omitting TCM-coding with respect to the LDPC-coded data or the turbo-coded data.

The constructing of the transmission stream may include: randomizing the stream; RS-encoding the randomized stream and, if the second service data is input, performing coding and formatting by using the LDPC-coding or the turbo-coding to construct a stream comprising the coded data and a connection area; interleaving the constructed stream; and coding the interleaved stream by using the TCM-coding, wherein the coding of the interleaved stream by using the TCM-coding includes: generating connection data with reference to a value stored in an internal memory used for the TCM-coding and inserting the connection data into the connection area.

The connection data may be arranged around an interface between the first service data and the second service on the interface in a structure of the interleaved stream to continuously perform TCM-coding with respect to parts before and after the second head or the second tail.

According to another aspect of the exemplary embodiments, there is provided a digital broadcast receiver including: a receiver which receives a transmission stream; a TCM-decoder which TCM-decodes a first area of the transmission stream; an advance decoder which LDPC-decodes or turbo-decodes a second area except the first area in the transmission stream; and a controller which controls the TCM-decoder to decode a TCM-coded part of the transmission stream and controls the advance decoder to decode a LDPC-coded or turbo-coded part of the transmission stream.

The transmission stream may include first service data and second service data. The first service data may include a first body, and a first head and a first tail, which protrudes from the first body and have horn shapes, in the transmission stream due to interleaving, the second service data may include a second body, and a second head and a second tail, which protrude from the second body and have horn shapes, in the transmission stream due to interleaving, and the first head or tail of the first service data may be engaged with the second head or tail of the second service data on an interface between the first and second service data. The second area may be the second body, and the first area may be the remaining part except the second body among the transmission stream.

The digital broadcast receiver may further include: a first switch which transmits the transmission stream to the TCM decoder and, if the second area comes, bypasses the transmission stream; a deinterleaver which multiplexes and deinterleaves the transmission stream TCM-decoded by the TCM decoder and the stream bypassed by the first switch; an RS decoder which RS-decodes the stream output from the deinterleaver; a deformatter which deformats the stream and provides the deformated stream to the advance decoder; a second switch which transmits the stream output from the deinterleaver to the RS decoder and, if data corresponding to the second area is input, transmits the stream to the deformatter; a derandomizer which derandomizes data decoded by the advance decoder and data decoded by the RS decoder; and a third switch transmits data output from the RS decoder and the deformatter to the derandomizer. The controller may control the first through third switches to respectively decode the first and second areas through the TCM decoder and the advance decoder.

The transmission stream may include first service data and second service data. The first service data may include a first body, and a head and a tail which protrude from the first body and have horn shapes, the second service data may include a second body, and a head and a tail which protrude from the second body and have horn shapes, and the head or the tail of the first service data may be engaged with the head or the tail of the second service data on an interface between the first and second service data.

Connection data may be arranged around an interface between the first and second service data in the interface to continuously perform TCM-coding. The deformatter may detect the connection data from the stream and discards the connection data.

The digital broadcast receiver may further include: a first switch which transmits the transmission stream to the TCM decoder and, if the second area comes, transmits the transmission stream to the advance decoder under control of the controller; a deinterleaver which deinterleaves data output from the TCM decoder and the advance decoder; an RS decoder which RS-decodes the data deinterleaved by the deinterleaver; a second switch which transmits the data deinterleaved by the deinterleaver to the RS decoder and, if data corresponding to the second area is input, bypasses the data; a derandomizer which derandomizes the data transmitted from the RS decoder and the second switch. The controller may control the first and second switches to respectively decode the first and second areas of the transmission stream through the TCM decoder and the advance decoder.

As described above, according to various exemplary embodiments of the present general inventive concept, a digital broadcast transmitter may apply a plurality of coding methods by using various methods to code and transmit a plurality of pieces of service data. A digital broadcast receiver may respectively decode and restore transmitted transmission streams by using a plurality of decoding methods. Therefore, data transmission efficiency may be improved.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a structure of a digital broadcast transmitter according to an exemplary embodiment;

FIGS. 2 and 3 are block diagrams illustrating a detailed structure of the digital broadcast transmitter according to various aspects of the exemplary embodiments;

FIG. 4 is a view illustrating a method of applying different coding methods in the digital broadcast transmitter;

FIGS. 5 and 6 are block diagrams illustrating a detailed structure of a digital broadcast transmitter according to another aspect of an exemplary embodiment;

FIGS. 7 through 15 are views illustrating structures of streams processed by the digital broadcast transmitter according to various aspects of the exemplary embodiments;

FIGS. 16 through 19 are views illustrating structures of trellis encoders according to various aspects of the exemplary embodiments; and

FIGS. 20 through 22 are block diagrams illustrating a structure of a digital broadcast receiver according to various aspects of the exemplary embodiments.

### DETAILED DESCRIPTION OF THE EXEMPLARY EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

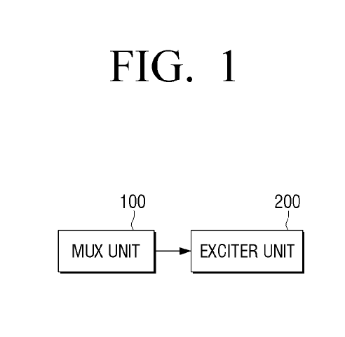

FIG. 1 is a block diagram illustrating a structure of a digital broadcast transmitter according to an exemplary embodiment of the present general inventive concept. Referring to FIG. 1, the digital broadcast transmitter includes a MUX unit 100 (e.g. a multiplexer or MUX) and an exciter unit 200 (e.g. exciter).

The MUX unit 100 may form a stream including a plurality of pieces of data.

The exciter unit 200 encodes and interleaves the stream formed by the multiplexer 100 to form a transmission stream and transmits the transmission stream to the outside.

The plurality of pieces of data of the stream formed by the MUX unit 100 may be variously formed. For example, first service data and second service data may be included in the stream. In detail, the first service data may be a normal data stream complying with conventional Advanced Television System Committed (ATSC) standards, and the second service data may be a mobile data stream or the like which may be received and processed by a mobile terminal device to be robust to reduce errors when viewed. Here, each of the first and second service data may be realized as a plurality of pieces of service data. In other words, a plurality of normal data streams or a plurality of mobile data streams may be included.

The exciter unit 200 encodes and interleaves the stream formed by the multiplexer 100. If interleaving is performed, positions of data in the stream are rearranged. If the exciter unit 200 performs interleaving when the MUX unit 100 stacks a plurality of pieces of stream data to form a stream, the first service data of the transmission stream includes a first body, a first head which protrudes from the first body and has a horn shape, and a first tail. Also, the second service data of the transmission stream includes a second body, a second head which protrudes from the second body and has a horn shape, and a second tail. An interface between the first and second service data refers to an interconnection between the first head or the first tail of the first service data and the second tail or the second head of the second service data.

The exciter unit 200 applies a coding method, which is different from coding methods applied to a remaining part of the second service data of the transmission stream, to at least a part of the second service data to code the at least part of the second service data. In other words, the exciter unit 200 may apply a coding method having high data transmission efficiency to the at least part of the second service data to code the at least part and apply a coding method defined by ATSC standards, etc. with respect to the remaining part to code the remaining part. Therefore, the exciter unit 200 may be realized to be compatible with an existing transmitting and receiving system and have high transmission efficiency with respect to particular service data (i.e., the second service data). For example, a coding method applied to the first service data may be a trellis-code modulation (TCM) coding method, and the coding method applied to the at least part of the second service data may be a Low Density Parity Check (LDPC) coding method or a turbo coding method. Hereinafter, the LDPC or turbo coding method will be referred to as an advance encoding method.

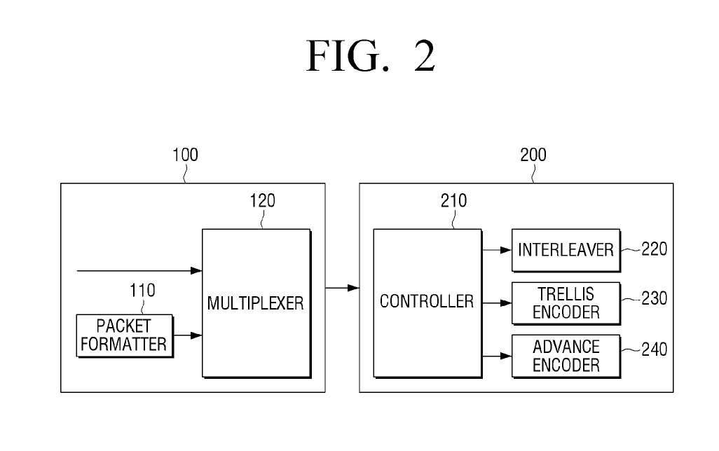

FIG. 2 is a block diagram illustrating a detailed structure of the digital broadcast transmitter according to an exemplary embodiment of the present general inventive concept. Referring to FIG. 2, the MUX unit 100 includes a packet formatter 110 and a multiplexer 120. The exciter unit 200 includes a controller 210, an interleaver 220, a trellis encoder 230, and an advance encoder 240.

The packet formatter 110 is an element which receives and formats the first or second service data. The packet formatter 110 performs packet formatting to appropriately determine and arrange a position of service data. For example, the packet formatter 110 may format a whole area allocated to the second service data to arrange the second service data in the whole area.

Although not shown in FIG. 2, a frame encoder (not shown), a block processor (not shown), a group formatter (not shown), a signaling encoder (not shown), etc. may be further included in front of the packet formatter 110.

The frame encoder is an element which performs Reed Solomon (RS) frame encoding. In detail, the frame encoder may receive service data from a source to construct the predetermined number of RS frames. For example, if one service is an M/H ensemble unit including a plurality of M/H parades, the frame encoder constructs the predetermined number of RS frames with respect to each of the M/H parades. In detail, the frame encoder may randomize input mobile data, perform RS-CRC encoding with respect to the input mobile data, and respectively classify the RS frames according to a preset RS frame mode in order to output the predetermined number of RS frames.

The block processor performs block-coding with respect to a stream output from the frame encoder. The block processor may divide the RS frames input from the frame encoder into blocks. In other words, the block processor combines the mobile data of the RS frames according to a preset block mode to construct Serially Concatenated Convolutional Code (SCCC) blocks and convert the SCCC blocks from a byte unit to a bit unit. The block processor performs convolutional encoding and symbol interleaving with respect to the converted data and converts and outputs the data to a byte unit. As described above, coding may be performed in the unit of blocks.

The group formatter receives the stream processed by the block processor and forms the stream in the unit of groups. In detail, the group formatter maps data pieces output from the block processor in appropriate positions of the stream and adds base data, signaling data, initialization data, etc. The group formatter also adds placeholder bytes for normal data, an MPEG-2 header, a non-systematics RS parity, etc. and dummy bytes for matching group formats.

The signaling encoder is an element which encodes signaling data. The signaling data refers to various types of information necessary for processing the transmission stream. The signaling encoder may appropriately process the signaling data and provide the processed signaling data to the group formatter. In detail, the signaling data may be used by a Transmission Parameter Channel (TPC), a Fast Information Channel (FIC). TPC is to provide various types of parameters such as various types of Forward Error Correction (FEC) mode information, M/H frame information, etc. The FIC is to acquire a fast service of a receiver and includes cross layer information between a physical layer and an upper layer. If such TPC information and FIC information are provided to the signaling encoder, the signaling encoder appropriately processes the TPC information and FIC information and provides the TPC information and FIC information as signaling data.

The packet formatter 110 may remove various placeholders added to the stream by the group formatter and add an MPEG header having a packet identification (PID) of the mobile data. Therefore, the packet formatter 110 outputs a stream including groups each having the preset number of packets. For example, the packet formatter 110 may output 118 TS packets.

The multiplexer 120 multiplexes the first service data input through an additional input route and the second service data input through the packet formatter 110 to construct the stream.

In FIG. 2, the first service data is directly input into the multiplexer 120, and the second service data is formatted through the packet formatter 110 and then input into the multiplexer 120. However, the opposite case is also possible. Also, the packet formatter 110 and the above-described several elements may be individually provided with respect to each of the first and second service data. In other words, various types of elements may be provided on the input route of the first service data to format the first service data.

As described above, the structure of the MUX unit 110 may be variously realized to construct at least one or more service data, i.e., mobile service data, in an appropriate format. In particular, if a plurality of mobile services are provided, the MUX unit 100 may include a plurality of elements.

If the MUX unit 100 constructs the stream, the controller 210 of the exciter unit 200 controls the interleaver 220, the trellis encoder 230, the advance encoder 240, etc. to interleave the stream and code areas of the stream by using different coding methods.

The controller 210 first controls the interleaver 220 to interleave the stream and may control the advance encoder 240 to encode only a preset area of the second service data of the interleaved stream.

As a first example, the controller 210 may control the advance encoder 240 to advance-encode only the second body. In this case, the controller 210 may control the trellis encoder 230 to TCM-code the remaining parts except the second body, i.e., the first body and the first head/tail of the first service data and the second head/tail of the second service data.

As a second example, the controller 210 may control the advance encoder 240 to advance-encode only an area including parts of the second head and the second tail protruding from the second body and may control the trellis encoder 230 to TCM-code the remaining parts, i.e., the remaining part of the second head, the remaining part of the second tail, and the first body and the first head/tail of the first service data.

As a third example, the controller 210 may control the advance encoder 240 to advance-encode a whole area in which the second service data is arranged, i.e., the second body and the second head/tail and may control the trellis encoder 230 to TCM-code the remaining part including the first body and the first head/tail.

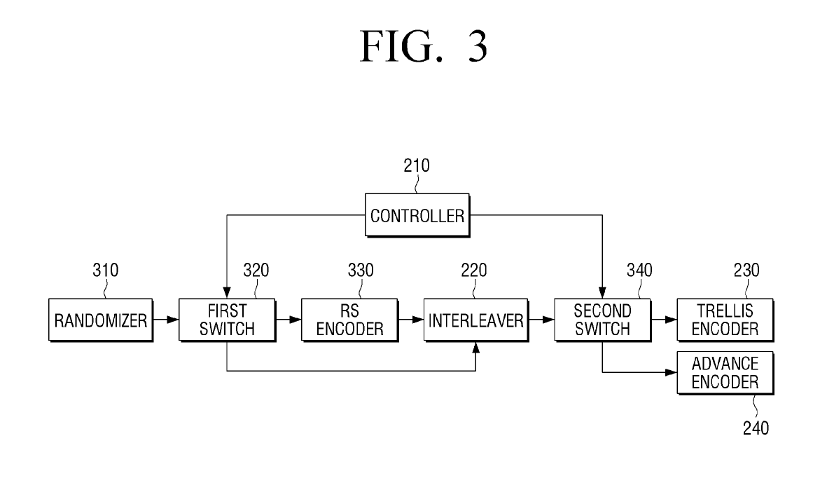

FIG. 3 is a block diagram illustrating a detailed structure of the digital broadcast transmitter according to the above-described second or third example. Referring to FIG. 3, the digital broadcast transmitter includes a randomizer 310, a first switch 320, an RS encoder 330, the interleaver 220, a second switch 340, a trellis encoder 230, the advance encoder 240, and the controller 210.

The randomizer 310 receives and randomizes the stream constructed by the MUX unit 100.

The first switch 320 performs a switching operation of transmitting the randomized stream to the RS encoder 330 or bypassing the randomized stream to transmit the stream to the interleaver 220. The switching operation may be performed under control of the controller 210. The switching operation may be performed when a preset stream area is input. In other words, if the controller 210 is realized as in the first example, the first switch 320 transmits the randomized stream to the RS encoder 330 and then switches the randomized stream when the second body is input, in order to transmit the stream to the interleaver 220.

If the controller 210 is realized as in the second example, the first switch 320 transmits the transmission stream to the interleaver 220 from a transmission unit when parts of the second head/tail start.

The RS encoder 330 RS-encodes the stream transmitted through the first switch 320 to add RS parity to the stream.

The interleaver 220 multiplexes the stream transmitted through the RS encoder 330 and the stream bypassed from the first switch 320 to perform interleaving.

The second switch 340 performs switching to transmit the stream output from the interleaver 220 to one of the trellis encoder 230 and the advance encoder 240.

In other words, the second switch 340 transmits the stream output from the interleaver 220 to the trellis encoder 230 and then performs switching if a preset stream area is input to transmit subsequent streams to the advance encoder 240. Here, the preset stream area may vary according to the above-described first and second examples.

The trellis encoder 230 or the advance encoder 240 trellis-encodes or advance-encodes the stream transmitted from the second switch 340. As described above, the advance-encoding may be LDPC coding or turbo coding.

The controller 210 may appropriately control the first and second switches 320 and 340 to perform LDPC coding or turbo coding from a desired time. A control operation of the controller 210 may be performed based on the signaling data transmitted from the MUX unit 100.

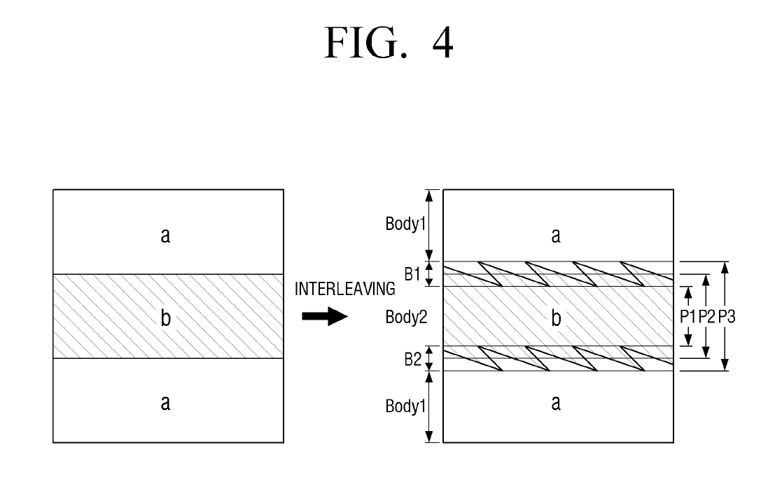

FIG. 4 is a view illustrating a switching time according to various exemplary embodiments of the present general inventive concept. Referring to FIG. 4, if interleaving is performed when a stream including first service data and second service data is constructed, areas ‘a’ and ‘b’ respectively become body and head/tail areas. Here, a first body refers to a part which is filled with only the first service data within one transmission stream unit, and a second body refers to a part which is filled with only second service data within one transmission stream unit. The head refers to a horn-shaped area which protrudes from the body above the stream, and the tail refers to a horn-shaped area which protrudes from the body below the stream. The first service data areas ‘a’ are engaged with the second service data areas ‘b’ at their interfaces B1 and B2. In other words, the tail of the area ‘a’ is engaged with the tail of the area ‘b’ at the upper interface B1, and the head of the area ‘a’ is engaged with the head of the area ‘b’ at the lower interface B2.

As described above, according to the first example of the present general inventive concept, the interleaved stream may be designed so that only the second body is advance-encoded in section P1, and the remaining part is TCM-coded.

According to the second example of the present general inventive concept, in section P2, only a transmission stream unit including a second head/second tail protruding to a predetermined part based on the second body, and the remaining part may be TCM-coded.

According to the third example of the present general inventive concept, in section P3, a transmission stream unit including the second head/second tail may be advance-encoded, and the remaining part may be TCM-coded.

In another aspect of an exemplary embodiment, only the second service data may be advance-encoded, and the remaining part may be TCM-coded. In this case, connection data may be arranged to connect the second head and the second tail to each other in order to consecutively perform TCM-coding with respect to data before and after the second head or the second tail.

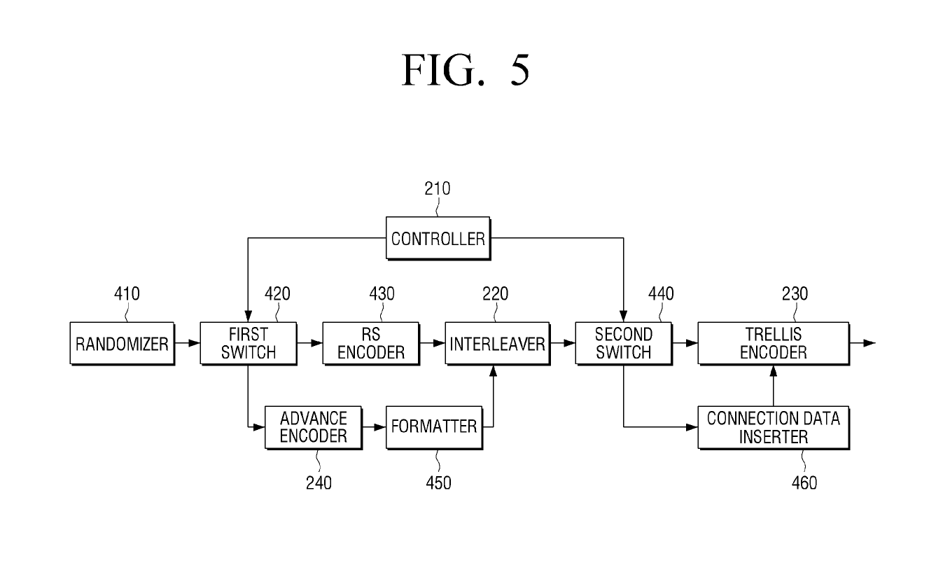

FIG. 5 is a block diagram illustrating a structure of a digital broadcast transmitter according to another exemplary embodiment of the present general inventive concept. Referring to FIG. 5, the digital broadcast transmitter includes a randomizer 410, first switch 420, an RS encoder 430, an advance encoder 240, a formatter 450, an interleaver 220, a second switch 440, a trellis encoder 230, a connection data inserter 460, and a controller 210.

The randomizer 410 randomizes the stream constructed by the MUX unit 100.

The first switch 420 performs switching under control of the controller 210 to transmit the randomized stream to the RS encoder 430 or the advance encoder 240.

The RS encoder 430 RS-encodes the transmitted stream, and the advance encoder 240 advance-encodes the stream. The stream advance-encoded by the advance encoder 240 is input into the formatter 450.

The formatter 450 provides a connection area in a predetermined area of the input stream to construct a stream including the connection area. Here, the connection area refers to an area corresponding to an interface between first service data and second service data in the stream interleaved by the interleaver 220.

The interleaver 220 receives the stream from the RS encoder 430 and the stream from the formatter 450 and interleaves the streams.

The second switch 440 transmits the interleaved streams to the trellis encoder 230 and then transmits the interleaved streams to the connection data inserter 460 if switching is performed. The connection data inserter 460 generates connection data with reference to a storage value of an internal memory used immediately before being switched by the trellis encoder 230 and inserts the connection data into the connection area. If the connection data is completely inserted into the connection area, the second switch 440 is re-switched to the trellis encoder 230 at a time when a second head or a second tail ends. In this case, parts before and after the second head or the second tail may be consecutively TCM-coded through the connection data. The connection data will be described in more detail later.

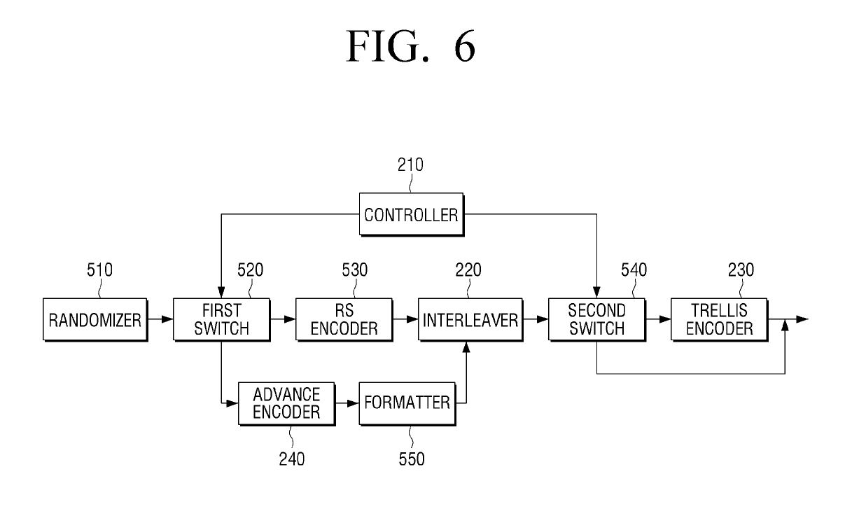

FIG. 6 is a block diagram illustrating a detailed structure of a digital broadcast transmitter according to another exemplary embodiment of the present general inventive concept.

Referring to FIG. 6, the digital broadcast transmitter includes a randomizer 510, a first switch 520, an RS encoder 530, an interleaver 220, a second switch 540, a trellis encoder 230, an advance encoder 240, a formatter 550, and a controller 210.

The randomizer 510 randomizes the stream constructed by the MUX unit 100.

The first switch 520 transmits the randomized stream to the RS encoder 530 and then transmits the randomized stream to the advance encoder 240 if a preset stream part is input. The advance encoder 240 advance-encodes the transmitted stream, and the formatter 550 adds connection data to the advance-encoded stream to construct a stream.

Here, the connection data refers to data which is arranged around an interface between first service data and second service data in an interface of the interleaved stream to connect a second head and a second tail to each other in order to consecutively TCM-coded parts before and after the second head or the second tail. Base data may be used as the connection data.

The interleaver 220 receives the stream processed by the RS encoder 530 and the stream processed by the formatter 550, interleaves the streams, and transmits the interleaved streams to the second switch 540. The second switch 540 selects the trellis encoder 230 to transmit the stream to the trellis encoder 230 until the second data is input and then bypasses the stream if the second service data is input.

As in the exemplary embodiments of FIGS. 5 and 6, advance-encoding may be performed before interleaving so that the interleaving is performed. Trellis encoding may be performed with respect to only a remaining part except advance-encoded data. Connection data may be used for continuity of trellis encoding in a head/tail part.

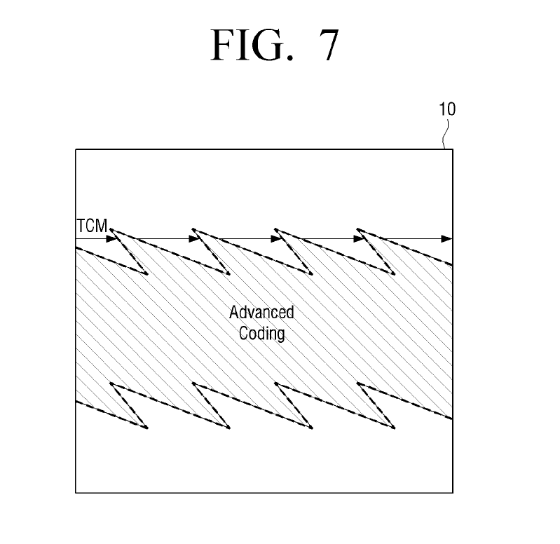

FIG. 7 is a view illustrating a structure of a stream.

If interleaving is performed after advance-encoding is performed, a stream 10 in which advance-coded data is arranged as a second body, a second head, and a second tail is constructed. Trellis encoding is performed with respect to a remaining part except second service data. In other words, within an interface, first service data and second service data are mixed even within one transmission stream unit. Therefore, TCM-coding is performed with respect to the first service data and stops when the second head or the second tail appears. The TCM-coding resumes when the second head or the second tail ends.

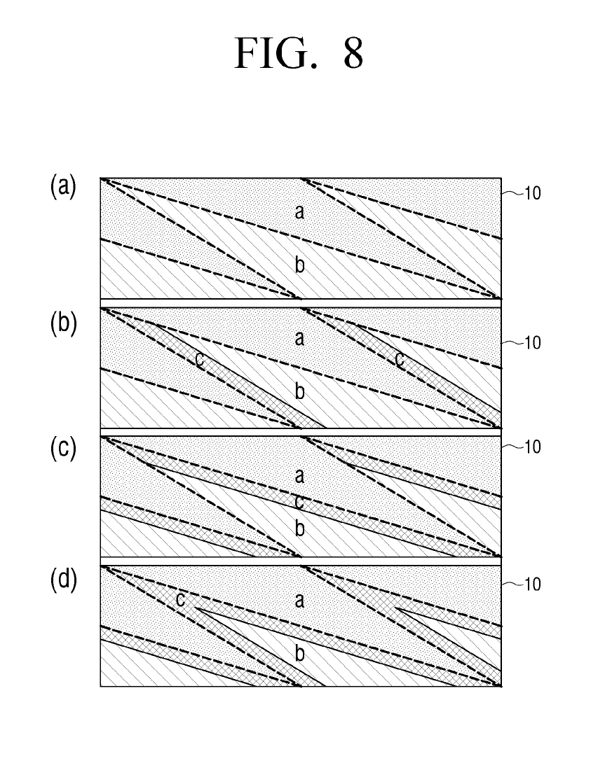

FIGS. 8A through 8D are views illustrating a method of arranging connection data to consecutively perform TCM-coding according to various exemplary embodiments of the present general inventive concept.

FIG. 8A illustrates an interface between first service data and second service data, i.e., a part in which a tail of area ‘a’ and a head of area ‘b’ are engaged with each other, in a stream 10.

Referring to FIG. 8B, connection data ‘c’ is inserted into a part of area ‘b’ adjacent to an interface between areas ‘a’ and ‘b’, in detail, a left interface.

Referring to FIG. 8C, connection data ‘c’ is inserted into a part of an area ‘b’ adjacent to the vicinity of an interface between areas ‘a’ and ‘b’, in detail, a right interface.

Referring to FIG. 8D, connection data ‘c’ is inserted into area ‘b’ adjacent to whole interface between areas ‘a’ and ‘b’, in detail, both right and left interfaces.

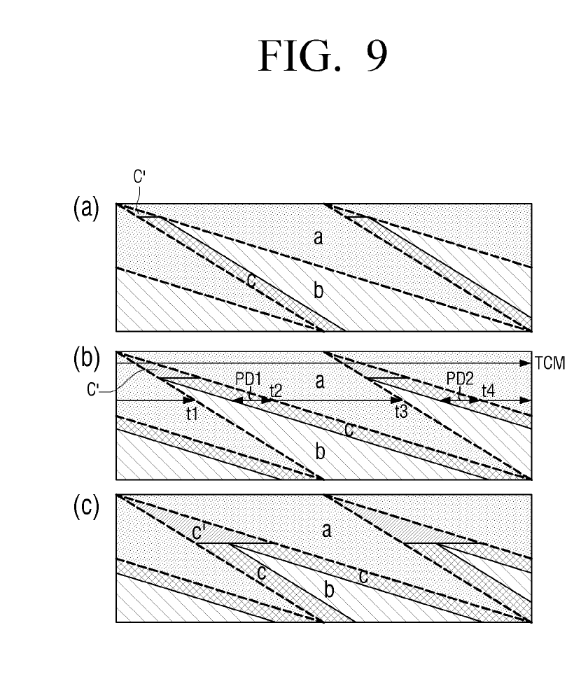

FIGS. 9A through 9C are views illustrating a method of arranging connection data to consecutively perform TCM-coding according to other various exemplary embodiments of the present general inventive concept.

As shown in FIGS. 9A through 9C, a head or a tail has a horn shape, and thus connection data is arranged on a left interface, a right interface, or both the left and right interfaces. Even in this case, an upper part of the connection data does not coexist with area ‘b.’ In other words, only connection data coexists with the area ‘a’ in a transmission stream unit including an upper part C′ of a connection area. Therefore, TCM-coding may be performed without inserting the connection data into the upper part C′, and thus the upper part C′ may be filled with first service data or other null data, etc. may be inserted into the upper part C′ to perform TCM-coding.

As shown in FIG. 9B, in a transmission stream unit in which area ‘b’ and area ‘a’ coexist, TCM-coding is performed, and then switching is performed at an interface t1 on which the areas ‘a’ and ‘b’ are engaged with each other to stop TCM-coding. In this state, bypassing is performed, and then switching is performed at a time t2 to resume TCM-coding. Here, in a connection area of the corresponding transmission stream unit, i.e., in part PD1, connection data is inserted as the same value as that stored in an internal memory of the trellis encoder 230 at the time t1. Therefore, when TCM-coding resumes at the time t2, TCM-coding may be continuously performed with TCM-coding performed to the time t1. A length of the section PD1 may vary according to the number of trellis encoders installed in the trellis encoder 230. In other words, if 12 trellis encoders are used, a connection area in which 12 memory values may be recorded, i.e. the section PD1, may be provided. Therefore, TCM-coding resumes from the time t2 and then stops and is bypassed at a time t3. After connection data is inserted into section PD2, TCM-coding resumes at a time t4. TCM-coding may be performed with respect to a remaining part except only the second service data by using this method. TCM-coding is not performed in a transmission stream unit including a body area, and thus an insertion of connection data may be omitted.

As described above, a transmission stream unit may be variously set and may be one segment unit according to an exemplary embodiment. In other words, in the stream structures of FIGS. 8 and 9, one horizontal line from the left to the right may be one segment unit.

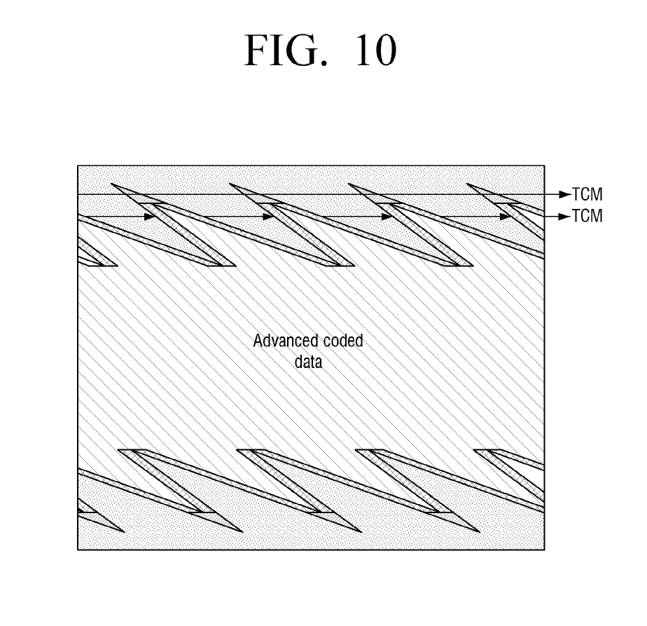

FIG. 10 is a view illustrating a process of performing TCM-coding with respect to a stream in which connection data is arranged around both interfaces. Referring to FIG. 10, TCM-coding is performed with respect to end areas of a head and a tail but stops in a connection area. After the head/tail pass, TCM-coding resumes.

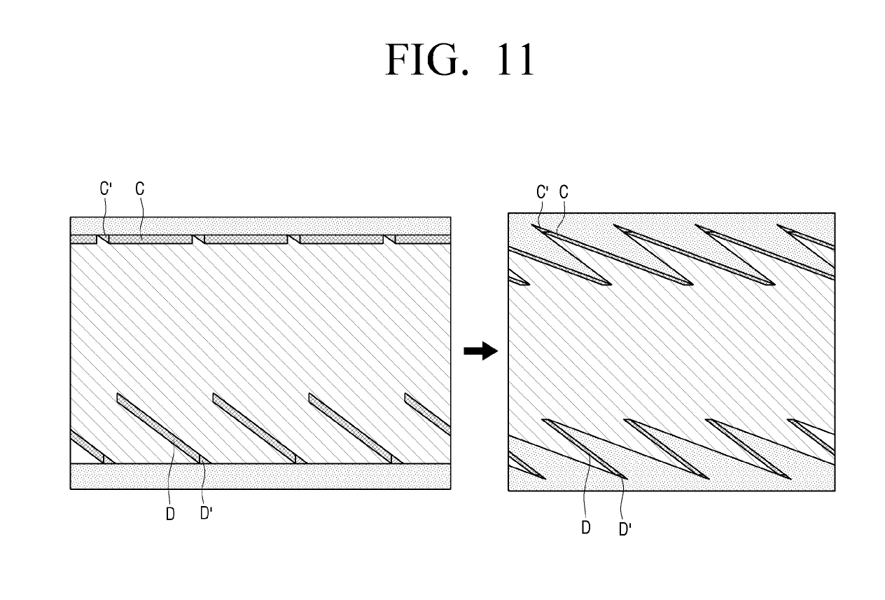

FIGS. 11 through 15 are views illustrating connection data or a connection area in a stream through a formatter, according to various exemplary embodiment of the present general inventive concept.

FIG. 11 illustrates a stream structure in which connection data is arranged around a′ back interface in area ‘b.’ Referring to FIG. 11, second service data is arranged in a stream unit (e.g., a packet) connected to first service data in area ‘b.’ In this case, if 38 packets are allocated to the second service data, the second service data is arranged from a place in which the 39 packets start. In this case, connection data or connection areas C and C′ may be arranged in parallel in at least one or more packet in which the second service data is first arranged. Also, connection data or connection areas D and D′ may be arranged in diagonal shapes in at least one or more packets of a last part of an area allocated to the second service data. If the exciter unit 200 performs interleaving after a stream is constructed in a form as described above, a second service data area is rearranged in a form including a head/tail and a body as on the right side of FIG. 11. For the descriptive convenience, these are respectively referred to as a second body, a second head, and a second tail.

The formatter may perform formatting as in the left stream structure of FIG. 11. Therefore, connection data or connection areas C and D are generated around back interface in the second head and the second tail. Also, instead of connection data, first service data may be arranged in end parts C′ and D′ of the second head and the second tail. In other words, the first service data may be inserted into a part of an area allocated to the second service data.

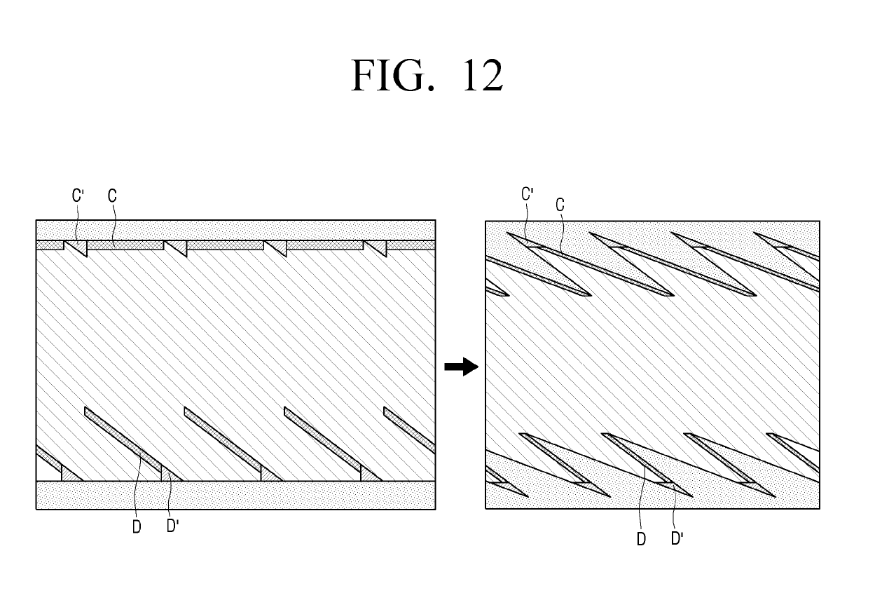

FIG. 12 illustrates connection data which is arranged around back interfaces of a second head and a second tail as in FIG. 11. Differently from FIG. 1, in FIG. 12, sizes of end parts C′ and Dl of the second head and the second tail are relatively large so that a larger amount of first service data is inserted into the end parts C′ and D′.

If connection data is arranged around a back interface as shown in FIGS. 11 and 12, the same value as a memory storage value after TCM-encoding is performed with respect to first service data around a front interface may be used as the connection data. Therefore, TCM-coding with respect to data after the back interface may be performed right after TCM-coding with respect to data before the back interface.

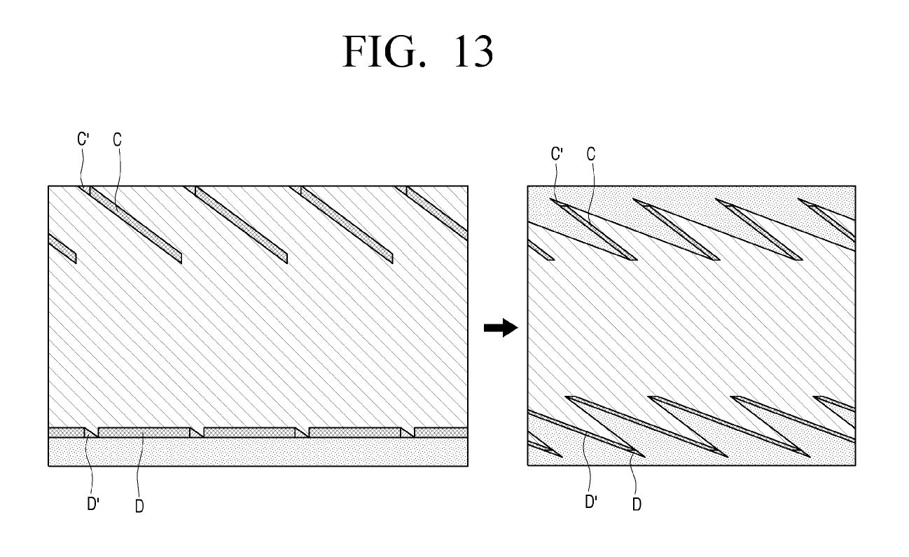

FIG. 13 illustrates connection data which is arranged around a front interface in a second head and a second tail. In a left stream of FIG. 13, if connection data or connection areas are arranged in diagonal shapes from a first packet of areas allocated to second service data, the connection data or the connection areas are rearranged around the front interface in the second head after interleaving.

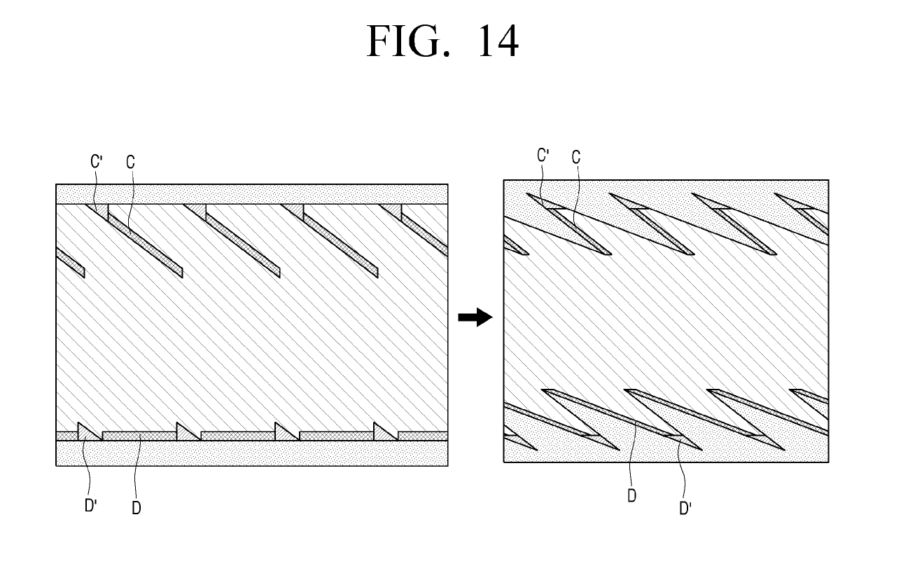

FIG. 14 illustrates connection data which is arranged around a front interface in a second head and a second tail as in FIG. 12. In this case, sizes of end parts C′ and D′ of the second head and the second tail are larger than sizes of end parts of the second head and the second tail of FIG. 13.

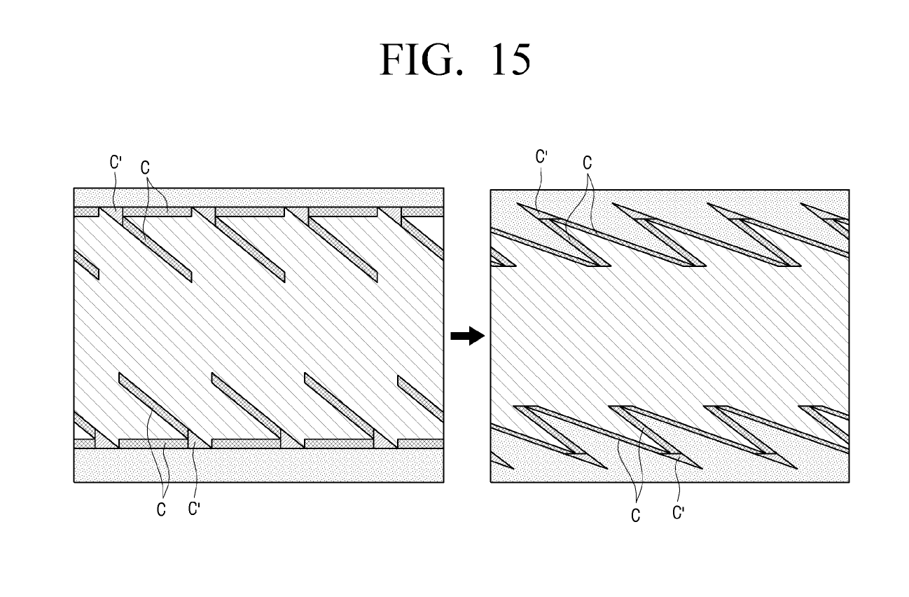

FIG. 15 illustrates connection data which is arranged around both interfaces in a second head and a second tail. Even in this case, another data not second service data, i.e., first service data, is arranged in end parts C′ and D′ of the second head and the second tail to perform TCM-coding.

If connection data is arranged not around a back interface but around a front interface as in FIGS. 13 and 14, the connection data arranged around the front interface may be initialization data which is to initialize internal memories of the trellis encoder 230 to a preset value. In other words, the internal memories may be initialized to 0 or another value by using the connection data to prevent the internal memories from being coded to another value due to a memory storage value when subsequent TCM-coding is performed. A structure of the trellis encoder 230 capable of performing initialization by using the connection data will be described later with reference to the drawings.

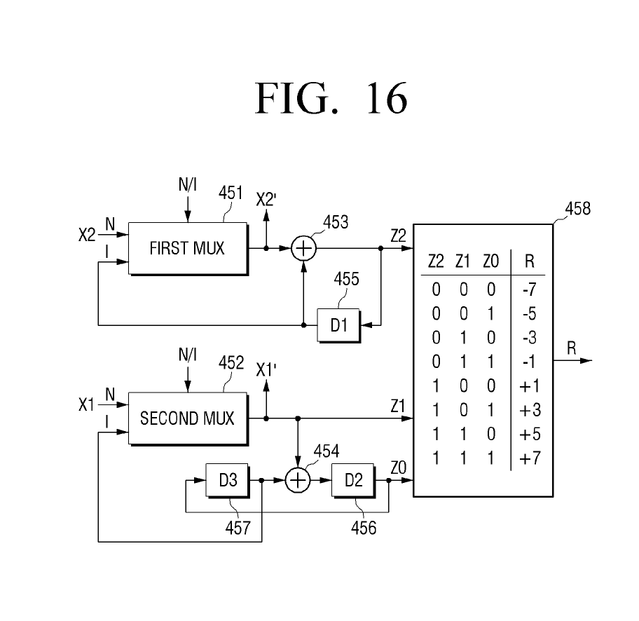

FIGS. 16 through 10 illustrate a structure of one of a plurality of trellis encoders installed in the trellis encoder 230.

Referring to FIG. 16, the trellis encoder includes first and second MUXs 451 and 452, first and second adders 453 and 454, first, second, and third memories 455, 456, and 457, and a mapper 458.

The first MUX 451 receives data N of a stream and value I stored in the first memory 455 and outputs one value, i.e., N or I, according to a control signal N/I. In detail, a control signal which is to select I when a value corresponding to a connection data section is input is applied to the first MUX 451, the first MUX 451 outputs I. The first MUX 451 outputs N in other sections. The second MUX 452 also outputs I only in a connection data section.

Therefore, the first MUX 451 outputs an interleaved value through a back end in a section which is not a connection data section, and the output value is input into the first adder 453 along with a value stored in the first memory 455. The first adder 453 performs logical operation, e.g., XOR, on the input values to output Z2. In this state, the value stored in the first memory 455 is selected and output by the first MUX in the connection data section. Therefore, the two same values are input into the first adder 453, and thus a value of the logical operation becomes a constant value. In other words, if XOR is performed, 0 is output. An output value of the first adder 453 is input into the first memory 455, and thus the value of the first memory 455 is initialized to 0.

In the second MUX 452, a value stored in the third memory 457 is selected and output by the second MUX 452 in the connection data section. The output value is input into the second adder 454 along with the value stored in the third memory 457. The second adder 454 performs logical operation on the two input values and outputs a value of the logical operation to the second memory 456. As described above, the values input into the second adder 454 are the same, and thus a logical operation value of the same values, e.g., 0 in the case of XOR, is input into the second memory 456. Therefore, the second memory 456 is initialized. The value stored in the second memory 456 is shifted and stored in the third memory 457. Therefore, when next connection data is input, a current value of the second memory 456, i.e., 0, is input into the third memory 457, and thus the third memory 457 is also initialized.

The mapper 458 receives the output value of the first adder 453, the output value of the second MUX 452, and the output value of the second memory 456, maps the output values as a corresponding symbol value R, and outputs the symbol value R. For example, if Z0, Z1, and Z2 are respectively output as 0, 1, and 0, the mapper 458 outputs symbol −3.

Since the RS encoders 430 and 530 are positioned before the trellis encoder 230, parity is pre-added to a value input into the trellis encoder 230. Therefore, since some value of data is changed due to initialization performed by the trellis encoder 230, the parity is to be changed. For this purpose, an RS encoder (not shown) may be used.

The RS encoder changes a value of a connection data section by using X1′ and X2′ output from the trellis encoder 230 to generate a new parity. The RS encoder may be referred to as a Non-Systematic RS encoder.

In FIG. 16, a memory value is initialized to 0 but may be initialized to a value which is not 0.

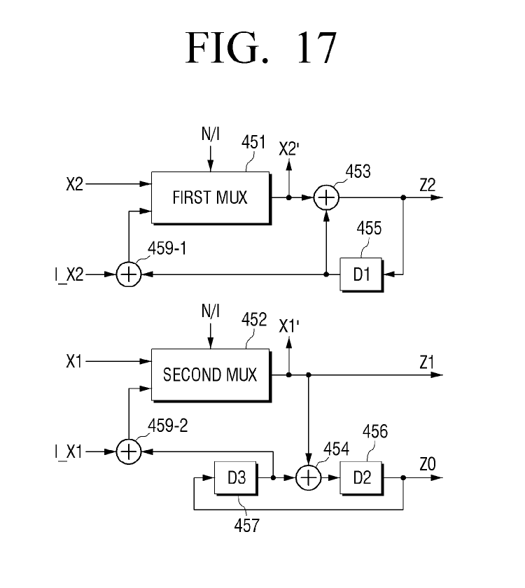

FIG. 17 is a view illustrating a trellis encoder according to another exemplary embodiment of the present general inventive concept.

Referring to FIG. 17, the trellis encoder includes first and second MUXs 451 and 452, first, second, third, and fourth adders 453, 454, 459-1, and 459-2, first, second, and third memories 455, 456, and 457. The mapper 458 is omitted in FIG. 17.

Therefore, the first MUX 451 may output one of stream input value X2 and a value of the third adder 459-1. I_X2 and a value stored in the first memory 455 are input into the third adder 459-1. I_X2 refers to a memory reset value. For example, if the first memory 455 is to be initialized to 1, I_X2 is input as 1. If the value stored in the first memory 455 is 0, an output value of the third adder 459-1 is 1, and thus the first MUX 451 outputs 1. Therefore, the first adder 453 performs XOR on the output value 1 of the first MUX 451 and the value 0 stored in the first memory 455 and stores result value 1 of XOR in the first memory 455. As a result, the first memory 455 is initialized to 1.

The second MUX 452 also selects and outputs an output value of the fourth adder 459-2 in the connection data section. The fourth adder 459-2 also outputs memory reset value I_X1 input from an external source and an XOR value of the third memory value 457. If 1 and 0 are respectively stored in the second and third memories 456 and 457 and are to be respectively initialized to 1 and 1, value 0 stored in the third memory 457 and XOR value 1 of I_X1 value 1 are output from the second MUX 452. The second adder 454 performs XOR on the output value 1 and the value 0 stored in the third memory 457, and result value 1 of XOR is input into the second memory 456. Value 1 stored in the second memory 456 is shifted to the third memory 457, and thus the third memory 457 is initialized to1. If second I_X1 is input as 1 in this state, XOR is performed on the value 1 of the third memory 457, and thus result value 0 of XOR is output from the second MUX 452. If the second adder 454 performs XOR on the value 0 output from the second MUX 452 and the value 1 stored in the third memory 457, result value 1 of XOR is input into the second memory 456, and the value stored in the second memory 456 is shifted and stored in the third memory 457. As a result, the second and third memories 456 and 457 may be initialized to 1.

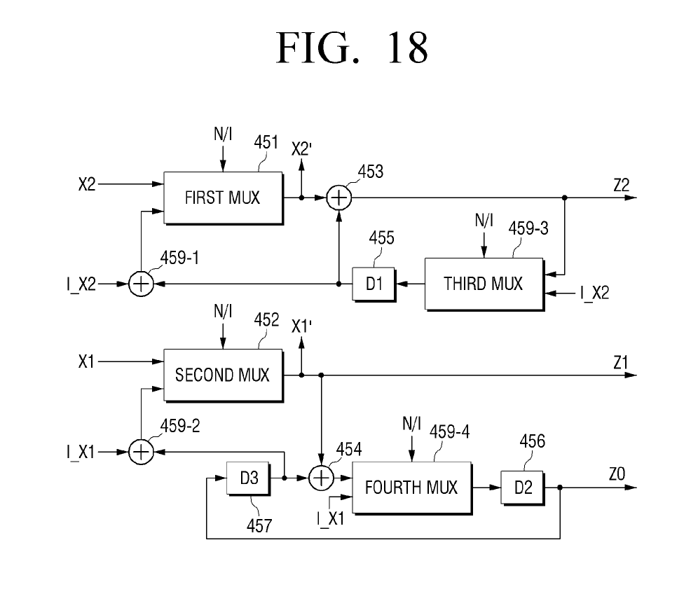

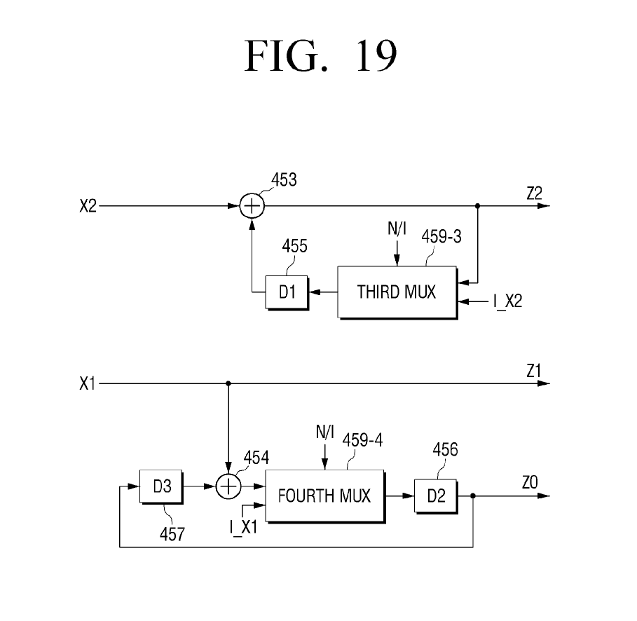

FIGS. 18 and 19 are views illustrating a trellis encoder according to various exemplary embodiments of the present general inventive concept.

Referring to FIG. 18, the trellis encoder may be realized to further include third and fourth MUXs 459-3 and 459-4 in the structure of the trellis encoder of FIG. 17. The third and fourth MUXs 459-3 and 459-4 may output values of the first and second adders 453 and 454 or I_X2 and I_X1 according to a control signal N/I. Therefore, values of the first, second, and third memories 455, 456, and 457 may be initialized to a desired value.

FIG. 19 illustrates a trellis encoder having a slightly simpler structure. Referring to FIG. 19, the trellis encoder includes first and second adders 453 and 454, first, second, and third memories 455, 456, and 457, and third and fourth MUXs 459-3 and 459-4. Therefore, the first, second, and third memories 455, 456, and 457 may be initialized according to values of I_X1 and I_X2 respectively input into the third and fourth MUXs 459-3 and 459-4. In other words, referring to FIG. 13, I_X2 and I_X1 are respectively input into the first and second memories 455 and 456 to be values of the first and second memories 455 and 456.

Detailed descriptions of operations of the trellis encoders of FIGS. 18 and 19 will be omitted.

As described above, connection data may be inserted to continuously perform coding of the trellis encoder 230.

A digital broadcast receiver according to an exemplary embodiment of the present general inventive concept may receive and process a transmission stream transmitted from the digital broadcast transmitter according to the above-described various exemplary embodiments.

A stream processing method performed in the digital broadcast transmitter as described above may include: constructing a stream including different types of first and second service data; and interleaving the stream to construct a transmission stream. The constructing of the stream may be performed by a structure such as the MUX unit 100 of FIG. 1, and the constructing of the transmission stream may be performed by a structure such as the exciter unit 200.

The transmission stream may be variously realized according to exemplary embodiments as described above.

The constructing of the stream may include performing formatting to arrange second service data only in an area corresponding to the second body among a whole area allocated to the second service data.

The constructing of the transmission stream may further include: randomizing the stream; RS-encoding the randomized stream and then bypassing the randomized stream if the second body is input; interleaving RS-encoded data and bypassed data; and performing LDPC-coding or turbo coding with respect to only the second body of the interleaved stream and performing TCM-coding with respect to the remaining part except the second body.

In this case, the stream may be constructed so that LDPC-coding or turbo coding is performed with respect to at least part of the second service data, and then the at least part is formatted to include connection data.

As in the above-described exemplary embodiment, only a connection area may be provided, and then connection data may be inserted according to a result of TCM-coding.

As described above, the stream processing method performed in the digital broadcast transmitter may be variously performed as described in the various structures according to the above-described various exemplary embodiments. Each of the stream processing methods has been described in the description of the digital broadcast transmitter, and thus repeated descriptions will be omitted. Also, the illustration of its flowchart will be omitted.

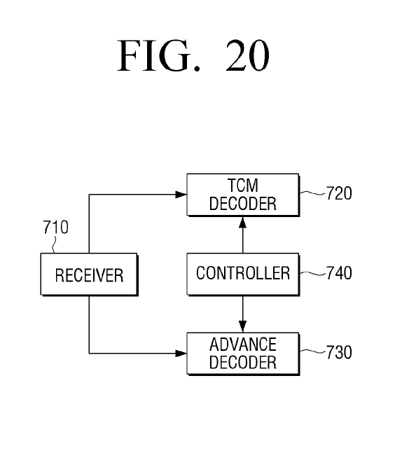

FIG. 20 is a block diagram illustrating a structure of a digital broadcast receiver according to an exemplary embodiment of the present general inventive concept. Referring to FIG. 20, the digital broadcast receiver includes a receiver 710, a TCM decoder 720, an advance decoder 730, and a controller 740.

The receiver 710 receives a transmission stream. The receiver 710 may include various types of elements such as an antenna, a demodulator, an equalizer, etc. Therefore, the receiver 710 may convert the transmission stream received through the antenna and restore the transmission stream through processing such as demodulation and equalization.

The TCM decoder 720 TCM-decodes a first area of the transmission stream.

The advance decoder 730 decodes a second area except the first area by using a LDPC decoding method or a turbo decoding method.

The controller 740 controls the TCM decoder 720 to decode a TCM-decoded part of the transmission stream and controls the advance decoder 740 to decode a LDPC-coded or turbo-coded part of the transmission stream.

Here, the transmission stream may be the transmission stream transmitted from the digital broadcast transmitter according to the above-described various exemplary embodiments.

In other words, the transmission stream may include first service data and second service data. In this case, the second area is a body part when the second service data is arranged in a form of a body and a head/tail due to interleaving but may be added to the body part to be a part including parts of the head/tail. The first area may be a remaining part except the second area among the transmission stream.

Alternatively, the second area may be a whole area to which the second service data is allocated or an area including a transmission stream unit including a part of the second service data.

As described above, the transmission stream may be coded and transmitted in various forms, and the digital broadcast receiver may have various structures according to a coding method or a coding time of the transmission stream.

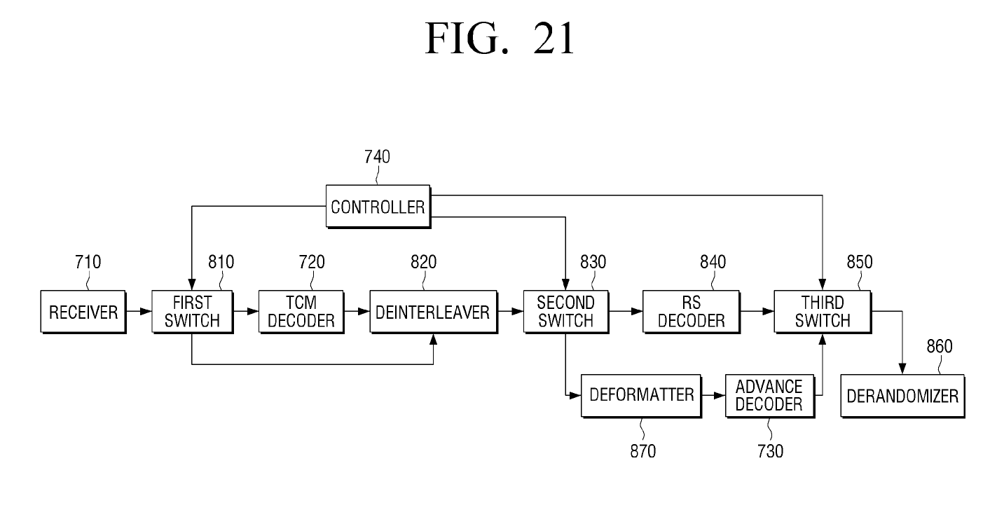

FIG. 21 is a block diagram illustrating a detailed structure of a digital broadcast receiver according to an exemplary embodiment of the present general inventive concept. Referring to FIG. 21, the digital broadcast receiver includes a receiver 710, a first switch 810, a TCM decoder 720, a deinterleaver 820, a second switch 830, an RS decoder 840, a third switch 850, a derandomizer 860, a deformatter 870, an advance decoder 730, and a controller 740.

If a transmission stream is received through the receiver 710, the first switch 810 transmits the received transmission stream to the TCM decoder 720 and then bypasses the transmission stream and transmits the transmission stream to the deinterleaver 820 if a stream part corresponding to a second area is input.

The TCM decoder 720 performs TCM-decoding with respect to only a stream part transmitted thereto. The deinterleaver 820 deinterleaves the stream output from the TCM decoder 720 and the stream immediately transmitted through the first switch 810.

The second switch 830 transmits the stream deinterleaved by the deinterleaver 820 to the RS decoder 840. The RS decoder 840 RS-decodes a stream part transmitted from the second switch 830.

If the stream part corresponding to the second area is input, the second switch 830 switches the stream part and transmits the stream to the deformatter 870.

The deformatter 870 deformats the transmitted stream to remove connection data from the stream and transmits the stream to the advance decoder 730.

Therefore, the advance decoder 730 LDPC-decodes or turbo-decodes and outputs the transmitted stream.

The third switch 850 alternatively selects the RS decoder 840 and the advance decoder 730 to combine the streams respectively output from the RS decoder 840 and the advance decoder 730 and transmits the combined stream to the derandomizer 860. The derandomizer 860 derandomizes the transmitted stream to restore first service data and second service data.

The controller 740 appropriately controls the first switch 810, the second switch 830, and the third switch 850 to perform TCM-decoding with respect to a first area and perform LDPC-decoding or turbo decoding with respect to the second area.

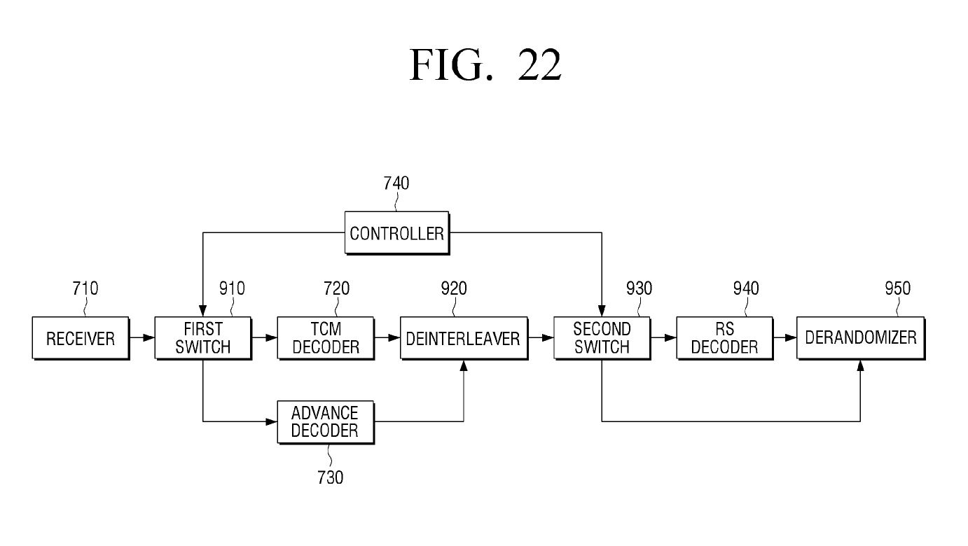

FIG. 22 is a block diagram illustrating a detailed structure of a digital broadcast receiver according to another exemplary embodiment of the present general inventive concept. Referring to FIG. 33, the digital broadcast receiver includes a receiver 710, a first switch 910, a TCM decoder 720, a deinterleaver 920, a second switch 930, an RS decoder 940, a derandomizer 950, an advance decoder 730, and a controller 740.

If a transmission stream is received through the receiver 710, the first switch 910 transmits the transmission stream to the TCM decoder 720 and then transmits the transmission stream if a second area comes. An operation of the first switch 910 is controlled by the controller 740. In other words, the controller 740 checks a start position and a coding method of a second area according to signaling data which is additionally transmitted or is included in the transmission stream. Therefore, the controller 740 controls the first switch 910 to select an appropriate decoder in an appropriate start position.

The TCM decoder 720 and the advance decoder 730 respectively TCM-decode and advance-decode and output the stream. Here, the advance-decoding is a concept corresponding to advance-encoding and may be LDPC-decoding or turbo-decoding.

The deinterleaver 920 receives and deinterleaves the streams respectively decoded by the TCM decoder 720 and the advance decoder 730.

The second switch 930 transmits the deinterleaved stream to the RS decoder 940 and then bypasses the deinterleaved stream and transmits the deinterleaved stream to the derandomizer 950 if a data stream corresponding to the second area is input. The RS decoder 940 RS-decodes the transmitted stream and transmits the RS-decoded stream to the derandomizer 950.

The derandomizer 950 derandomzies the streams respectively input from the second switch 930 and the RS decoder 940 to detect first service data and second service data.

As described above, the digital broadcast receiver may also be variously provided according to various exemplary embodiments. Descriptions of stream processing methods performed by these digital broadcast receivers are the same as contents described with reference to FIGS. 20, 21, and 22, and thus repeated descriptions and illustrations will be omitted.

In the above-described exemplary embodiments, LPDC-coding or turbo-coding is used as advance-encoding or advance-decoding but is not necessarily limited thereto. Therefore, other types of codes may be used.

Also, as described above, a plurality of service streams may be provided. In the above-described exemplary embodiment, first service data is ATSC normal data, and second service data is mobile data but are not necessarily limited thereto. In other words, the second service data may be ATSC normal data, and the first service data may be mobile data. Also, both the first and second service data may be ATSC normal data. In this case, the second service data may be new normal data different from the first service data.

Stream processing methods according to the above-described various exemplary embodiments of the present general inventive concept may be realized as a program code to be stored on various types of recording media which can be accessed by a processor or central processing unit (CPU). In detail, the program code may be stored on various types of computer-readable recording media such as a random access memory (RAM), a flash memory, a read only memory (ROM), an erasable programmable ROM (EPROM), an electronically erasable and programmable ROM (EEPROM), a register, a hard disk, a removable disk, a memory card, a universal serial bus (USB) memory, a CD-ROM, etc.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

1. A digital broadcast transmitter comprising:
a MUX which constructs a stream comprising different types of data, the different types of data including first service data and second service data;
an exciter which interleaves the stream constructed by the MUX to construct a transmission stream,
wherein the exciter interleaves the stream so that the first service data comprises a first body, and a first head and a first tail which protrudes from the first body and have horn shapes, the second service data comprises a second body, and a second head and a second tail which protrude from the second body and have horn shapes, and the first head or tail of the first service data is engaged with the second head or tail of the second service data on an interface between the first and second service data, performs Low Density Parity Check (LDPC)-coding or turbo-coding with respect to at least a part of the second service data of the transmission stream, and performs trellis-code modulation (TCM)-coding with respect to a remaining part of the transmission stream.

2. The digital broadcast transmitter of claim 1, wherein the exciter comprises:
an interleaver which interleaves the stream;
a trellis encoder which performs the TCM-coding;
an advance encoder which performs the LDPC coding or the turbo coding; and
a controller which controls the advance encoder to code the second body of the interleaved stream and controls the trellis encoder to code the remaining part of the interleaved stream excluding the second body.

3. The digital broadcast transmitter of claim 2, wherein the MUX comprises:
a formatter which performs formatting to arrange the second service data in a whole area allocated to the second service data.

4. The digital broadcast transmitter of claim 1, wherein the exciter comprises:
a randomizer which randomizes the stream constructed by the MUX;
an RS encoder which performs RS-encoding;
a first switch which transmits the randomized stream to the RS encoder and, if the second body of the second service data is input, bypasses the RS encoder outputting bypassed data;
an interleaver which interleaves the stream RS-encoded by the RS encoder and the bypassed data output by the first switch;
a trellis encoder which performs the TCM coding;
an advance encoder which performs the LDPC-coding or the turbo-coding;
a second switch which switches the stream interleaved by the interleaver to the trellis encoder or the advance encoder; and
a controller which controls the second switch to transmit the second body of the second service data to the advance encoder and transmit the remaining part of the interleaved stream excluding the second body to the trellis encoder.

5. The digital broadcast transmitter of claim 1, wherein the exciter comprises:
a randomizer which randomizes the stream constructed by the MUX;
an RS encoder which performs RS-encoding;
an advance encoder which performs coding by using the LDPC-coding or the turbo-coding;
a formatter which formats data coded by the advance encoder to construct a stream comprising the data and connection data;
a first switch which transmits the randomized stream to the RS encoder and, if the area in which the second service data is arranged is received, transmits the randomized stream to the advance encoder;
an interleaver which multiplexes the streams transmitted from the formatter and the RS encoder to perform interleaving;
a trellis encoder which codes the stream interleaved by the interleaver by using a TCM-coding method; and
a second switch which transmits the stream interleaved by the interleaver to the trellis encoder and, if a part coded by the advance encoder is input, bypasses the trellis encoder.

6. The digital broadcast transmitter of claim 1, wherein the exciter comprises:
a randomizer which randomizes the stream constructed by the MUX;
an RS encoder which performs RS-encoding;
an advance encoder which performs coding by using the LDPC-coding or the turbo-coding;
a formatter which formats data coded by the advance encoder to construct a stream comprising connection data;
a first switch which transmits the randomized stream to the RS encoder and, if the second service data is input, transmits the randomized stream to the advance encoder;
an interleaver which multiplexes the streams transmitted from the formatter and the RS encoder to perform interleaving;
a trellis encoder which codes the stream interleaved by the interleaver by using the TCM-coding method;
a second switch transmits the stream interleaved by the interleaver to the trellis encoder and, if a part coded by the advance encoder is input, bypasses the trellis encoder; and
a connection data inserter which, if the trellis encoder transmits the part coded by the advance encoder transmitted to the second switch, generates connection data with reference to a value stored in an internal memory of the trellis encoder and inserts the connection data into a connection area.

7. The digital broadcast transmitter of claim 6, wherein the connection data is arranged around an interface between the first service data and the second service data on the interface in a structure of the interleaved stream to continuously perform TCM-coding with respect to parts before and after the second head or the second tail.

8. A method for processing a stream of a digital broadcast transmitter, the method comprising:
constructing a stream comprising different types of data, the different types of data including first service data and second service data; and
interleaving the stream to construct a transmission stream,
wherein the stream is interleaved so that the first service data comprises a first body, and a first head and a first tail which protrudes from the first body and have horn shapes, the second service data comprises a second body, and a second head and a second tail which protrude from the second body and have horn shapes, and the first head or tail of the first service data is engaged with the second head or tail of the second service data on an interface between the first and second service data, LDPC-coding or turbo-coding is performed with respect to at least a part of the second service data of the transmission stream, and trellis-code modulation (TCM)-coding is performed with respect to a remaining part of the interleaved stream.

9. The method of claim 8, wherein the LDPC-coding or the turbo-coding is performed with respect to only the second body, and the TCM-coding is performed with respect to a remaining part except the second body.

10. The method of claim 9, wherein the constructing of the stream comprises:
performing formatting to arrange the second service data in a whole area allocated to the second service data.

11. The method of claim 8, wherein the constructing of the transmission stream comprises:
randomizing the stream;
RS-encoding the randomized stream and, if the second body is input, bypassing the encoder outputting bypassed data;
interleaving the RS-encoded data and the bypassed data; and
performing the LDPC-coding or the turbo-coding with respect to the second body of the interleaved stream and performing the TCM-coding with respect to the remaining part of the interleaved stream excluding the second body.

12. The method of claim 8, wherein the constructing of the transmission stream comprises:
randomizing the stream;
performing RS-encoding with respect to the randomized stream and, if the second service data is input, performing coding and formatting by using the LDPC-coding or the turbo-coding to construct a stream comprising the coded data and connection data;
interleaving the constructed stream; and
coding the interleaved stream by using a TCM-coding method,
wherein the coding of the interleaved stream by using the TCM-coding method comprises omitting TCM-coding with respect to the LDPC-coded data or the turbo-coded data.

13. The method of claim 8, wherein the constructing of the transmission stream comprises:
randomizing the stream;
RS-encoding the randomized stream and, if the second service data is input, performing coding and formatting by using the LDPC-coding or the turbo-coding to construct a stream comprising the coded data and a connection area;
interleaving the constructed stream; and
coding the interleaved stream by using the TCM-coding,
wherein the coding of the interleaved stream by using the TCM-coding comprises: generating connection data with reference to a value stored in an internal memory used for the TCM-coding and inserting the connection data into the connection area.

14. The method of claim 13, wherein the connection data is arranged around an interface between the first service data and the second service data on the interface in a structure of the interleaved stream to continuously perform TCM-coding with respect to parts before and after the second head or the second tail.

15. A digital broadcast receiver comprising:
a TCM-decoder which TCM-decodes a first area of a transmission stream;
an advance decoder which LDPC-decodes or turbo-decodes a second area excluding the first area in the transmission stream; and
a controller which controls the TCM-decoder to decode a TCM-coded part of the transmission stream and controls the advance decoder to decode a LDPC-coded or turbo-coded part of the transmission stream.

16. The digital broadcast receiver of claim 15, wherein the transmission stream comprises first service data and second service data,
wherein
the first service data comprises a first body, and a first head and a first tail, which protrudes from the first body and have horn shapes, in the transmission stream due to interleaving, the second service data comprises a second body, and a second head and a second tail, which protrude from the second body and have horn shapes, in the transmission stream due to interleaving, and the first head or tail of the first service data is engaged with the second head or tail of the second service data on an interface between the first and second service data; and
the second area is the second body, and the first area is the remaining part of the transmission stream excluding the second body among the transmission stream.

17. The digital broadcast receiver of claim 15, wherein the transmission stream comprises first service data and second service data,
wherein
the first service data comprises a first body, and a first head and a first tail, which protrude from the first body and have horn shapes, in the transmission stream due to interleaving, the second service data comprises a second body, and a second head and a second tail, which protrude from the second body and have horn shapes, in the transmission stream due to interleaving, and the first head or tail of the first service data is engaged with the second head or tail of the second service data on an interface between the first and second service data;
the second area comprises at least a part of the second head, at least a part of the second tail, and the second body, and the first area is a remaining part of the transmission stream excluding the second area in the transmission stream.

18. The digital broadcast receiver of claim 15, further comprising:
a first switch which transmits the transmission stream to the TCM decoder and, if the second area comes, bypasses the TCM decoder;
a deinterleaver which multiplexes and deinterleaves the transmission stream TCM-decoded by the TCM decoder and the stream bypassed by the first switch;
an RS decoder which RS-decodes the stream output from the deinterleaver;
a deformatter which deformats the stream and provides the deformatted stream to the advance decoder;
a second switch which transmits the stream output from the deinterleaver to the RS decoder and, if data corresponding to the second area is input, transmits the stream to the deformatter;
a derandomizer which derandomizes data decoded by the advance decoder and data decoded by the RS decoder; and
a third switch transmits data output from the RS decoder and the deformatter to the derandomizer,
wherein the controller controls the first through third switches to respectively decode the first and second areas through the TCM decoder and the advance decoder.

19. The digital broadcast receiver of claim 18, wherein the transmission stream comprises first service data and second service data,
wherein the first service data comprises a first body, and a head and a tail which protrude from the first body and have horn shapes, the second service data comprises a second body, and a head and a tail which protrude from the second body and have horn shapes, and the head or the tail of the first service data is engaged with the head or the tail of the second service data on an interface between the first and second service data.

20. The digital broadcast receiver of claim 19, wherein connection data is arranged around an interface between the first service data and the second service data in the interface to continuously perform TCM-coding,
wherein the deformatter detects the connection data from the stream and discards the connection data.

21. The digital broadcast receiver of claim 15, further comprising:
a first switch which transmits the transmission stream to the TCM decoder and, if the second area comes, transmits the transmission stream to the advance decoder under control of the controller;
a deinterleaver which deinterleaves data output from the TCM decoder and the advance decoder;
an RS decoder which RS-decodes the data deinterleaved by the deinterleaver;
a second switch which transmits the data deinterleaved by the deinterleaver to the RS decoder and, if data corresponding to the second area is input, bypasses the RS decoder;
a derandomizer which derandomizes the data transmitted from the RS decoder and the second switch,
wherein the controller controls the first and second switches to respectively decode the first and second areas of the transmission stream through the TCM decoder and the advance decoder.

22. A digital broadcast transmitter comprising:
a MUX which constructs a stream comprising different types of data, the different types of data including first service data and second service data;
an exciter which interleaves the stream constructed by the MUX to construct a transmission stream,
wherein the exciter performs Low Density Parity Check (LDPC)-coding or turbo-coding with respect to at least a part of the second service data of the transmission stream, and performs trellis-code modulation (TCM)-coding with respect to a remaining part of the transmission stream.

23. The digital broadcast transmitter of claim 23,
wherein the exciter interleaves the stream so that the first service data comprises a first body, and a first head and a first tail and the second service data comprises a second body, and a second head and a second tail,
wherein the first tail of the first service data is engaged with the second head of the second service data, and
wherein the first head of the first service data is engaged with the second tail of the second service data.
